(19) United States
(12) Patent Application Publication
(10) Pub. No.: US 2025/0066521 A1
(43) Pub. Date: Feb. 27, 2025

(54) Ion-Conducting Membranes

(71) Applicant: GREENLYZER US, INC., Boca Raton, FL (US)

(72) Inventor: Rich Masel, Boca Raton, FL (US)

(21) Appl. No.: 18/453,011

(22) Filed: Aug. 21, 2023

(51) Int. Cl. C08F 212/14; C08F 212/08; C08J 5/22; C25B 13/08

(52) U.S. Cl. CPC C08F 212/18; C08F 212/08; C08J 5/2231; C25B 13/08; C08F 2800/20; C08J 2325/08; C08J 2325/18

(57) ABSTRACT

An anion-conducting polymeric membrane can include vinylbenzyl-Rₛ vinylbenzyl-Rₓ and styrene. In some embodiments, Rₛ is a tetra methylimidazolium, and Rₛ is a positively changed amine. In some embodiments, the total weight of the vinylbenzyl-Rₛ groups is greater than 20% of the total weight of the membrane.

### FIELD OF THE INVENTION

The field of the invention is electrochemistry. The devices, systems, compositions, and membranes are useful for, among other things, the electrolysis of water and carbon dioxide, batteries, electric power generation using fuel cells, water purification and carbon dioxide capture systems.

### BACKGROUND OF THE INVENTION

Processes utilizing electrochemical cells for chemical conversions have been known for years. Generally, an electrochemical cell contains an anode, a cathode, and an electrolyte. Catalysts can be placed on the anode, the cathode, and/or in the electrolyte to promote the desired chemical reactions. During operation, reactants or a solution containing reactants are fed into the cell. Voltage is then applied between the anode and the cathode, to promote the desired electrochemical reactions. In the case of a water electrolyzer hydrogen is produced on the cathode and oxygen is produced on the anode.

Over the years, the use of a number of ion-conducting membranes has been discussed for use in these cells. Some of these ion-conducting membranes have been disclosed in U.S. Pat. Nos. 9,012,345; 9,370,773; 9,464,359; 9,481,939; 9,580,824; 9,555,367; 9,815,021; 9,849,450; 9,943,841; 9,945,040; 9,957,624; 9,982,353; 10,023,967; 10,047,446; 10,975,480; 10,147,974; 10,173,169; 10,396,329; 10,428,432; 10,724,142; 10,774,431 and U.S. patents application Ser. Nos. 15/922,883; 16/024,827; 16/552,952; and 16/429,868.

U.S. Pat. Nos. 9,982,353 and 10,724,142 disclose that these membranes are particularly suited for use in anion exchange membrane (AEM) water electrolyzers. The membranes disclosed in the 9,982,353 and 10,724,142 patents were tested with a 1 M KOH solution flowing in the anode and cathode.

Recently, there has been interest in running AEM water electrolyzers with a “dry cathode” (where the KOH solution is supplied to the anode, but not the cathode). Present commercial versions of the membranes do not run well with a dry cathode, likely because the water transport is insufficient.

### SUMMARY OF THE INVENTION

Mechanically robust anion conducting membranes that have modified water transport compared to those disclosed in U.S. Pat. Nos. 9,982,353 and 10,724,142 are disclosed.

In some preferred embodiments, the anion-conducting membrane includes a polymer comprising the reaction products of vinylbenzyl-Rₛ, vinylbenzyl-Rₓ and styrene wherein.
(a) Rₛ is positively charged amine or phosphine;
(b) vinylbenzyl-Rₓ comprises the reaction product of benzyl-X where X is a halogen with at least one of sodium-ethoxide, tripropyl amine, triethylamine, benzimidazole, 1-piperidineethanol, dimethylaminopyridine, 1 methyl pyrrolidine, methylpiperidine, N-methyl-D-glucamine;
(c) vinylbenzyl-Rₓ is a different chemical species than vinylbenzyl-Rₛ;
(d) the total weight of the vinylbenzyl-Rₛ is at least 10% of the weight of the polymer; and/or
(e) the total weight of the vinylbenzyl-Rₓ is at least 1% of the weight of the polymer.

In some preferred embodiments, the anion-conducting membrane includes a polymer comprising a reaction product of vinylbenzyl-Rₛ, vinylbenzyl-Rₓ and styrene, wherein:
(a) vinylbenzyl-Rₛ comprises a reaction product of tetramethylimidazolium and benzylchloride;
(b) vinylbenzyl-Rₓ comprises a reaction product of benzylchloride and at least one of the following compounds: sodium-ethoxide, tripropyl amine, triethylamine, benzimidazole, 1-piperidineethanol, dimethylaminopyridine, 1 methyl pyrrolidine, methylpiperidine, N-methyl-D-glucamine;
(c) the total weight of the vinylbenzyl-Rₛ is at least 20% of the weight of the polymer;
(d) the total weight of the vinylbenzyl-Rₓ is at least 10% of the weight of the polymer; and/or
(e) the total weight of the styrene is at least 20% of the weight of the polymer.

In some embodiments, the total weight of vinylbenzyl-Rₓ is at least 20% of the weight of the polymer.

In some embodiments, a step in the production of the anion-conducting membrane involves exposing the anion-conducting membrane to sodium-ethoxide.

In some embodiments, the vinylbenzyl-Rₓ comprises a reaction product of benzylchloride and N-methyl-D-glucamine.

In some embodiments, the anion-conducting membrane comprises a reaction product of vinylbenzyl-Rₛ, vinylbenzyl-Rₓ₁, vinylbenzyl-Rₓ₂ and styrene, further comprising wherein:
(a) vinylbenzyl-Rₓ₁ comprises a reaction product of benzylchloride and at least one of the following compounds: sodium-ethoxide, tripropyl amine, triethylamine, benzimidazole, 1-piperidineethanol, dimethylaminopyridine, 1 methyl pyrrolidine, methylpiperidine, N-Methyl-D-glucamine;
(b) vinylbenzyl-Rₓ₁ comprises a reaction product of benzylchloride and ethoxy-sodium;
(c) the polymer comprises at least 1% Vinylbenzyl-Rₓ₁; an
(d) the polymer comprises at least 10% Vinylbenzyl-Rₓ₂.

In some embodiments, the polymer has a molecular weight between 1000 and 10,000,000 atomic units (A.U.)

In some embodiments, the thickness of said anion-conducting membrane is between 10-300 micrometers.

In some embodiments, the membrane has an area specific resistance of 0.1 ohm-cm² or less in 1 M KOH at 60° C.

In some embodiments, a battery, fuel cell, electrolyzer, water purification system or CO₂ capture system can include the disclosed anion-conducting membrane.

In some preferred embodiments, vinylbenzyl-Rₛ comprises the reaction product of a benzyl-X, wherein X is a halogen, with at least one of: 1,2,2,6,6-pentamethylpiperidine, 1,2,2,5,5-pentamethylpyrrolidine, tetramethylimidazole, triethylamine, tripropylamine, trimethylamine, N-methylpiperdine, 1-ethylpiperidine, piperidine, 1,4′-bipiperidine, 1-methylpyrrolidine, 2,2,6,6-tetramethylpiperidine, pyrrolidine, 1-pyrrolidine ethanamine, 2,3,5-trimethylpyridine, 2,4,6-trimethylpyridine, 2,6-dimethylpyridine, 2,4-dimethylpyridine, 2,3,5-trimethylpyridine, 4-methyl-2-(1-pyrrolyl) pyridine, 2-methylpyridine, 3-methylpyridine, 4-methylpyridine, pyridine, 4,4′-dipyridyl, 2,2′-bipyridyl, tributylamine, N,N-diisopropylethylamine, triphenylamine, N,N-dimethylcyclohexylamine, N,N-dicyclohexylmethylamine, triphenylphosphine, 1,2-dimethylindole, indole, 1-methylindole, hexamethylenetetramine, 2,3,5,6-tetramethylpyrazine, 2,3,5-trimethylpyrazine, 2,3-dimethylpyrazine, 3-methylpyridazine, 2-methylpyrazine, 2,3-diethylpyrazine, ethylpyrazine, pyrazine, 1-methylimidazole, pyrimidine, 4-methylpyrimidine, pyridazine, triazole, 3,5-dimethyl-1,2,4-triazole, 1,2-dimethylimidazole, 2,4,5-triphenylimidazole, 1-decyl-2-methylimidazole, 1-(2-hydroxyethyl) imidazole, guanidine, tetramethyl guanidine, dipiperidine, dipyridine, ethylenediamine, propylenediamine, N,N,N′-trimethylethylenediamine, ethylenediaminetetraacetic acid, alkyldiamines, other diamines, ethanolamine, triethanolamine, methylethanolamine, dimethylethanolamine, propanolamine, 3-butenylmagnesium, isobutylmagnesium bromide, cyclohexylmagnesium chloride, and amino acid.

In some preferred embodiments, vinylbenzyl-Rₛ comprises the reaction product of tetramethylimidazole and a benzyl-X, wherein X is a halogen.

In some preferred embodiments, the polymer will have a molecular weight between 1000 and 10,000,000 atomic units (A.U.) preferably between 10,000 and 1,000,000 A.U., most preferably between 25,000 and 250,000 A.U.

In some preferred embodiments, the polymeric composition is in the form of a membrane. The membrane has a preferred thickness of 10-300 micrometers.

In some preferred embodiments, the membrane has an area specific resistance in 1 M KOH at 60° C. of 0.1 ohm-cm² or less.

### BRIEF DESCRIPTION OF THE DRAWINGS

FIG. 1 is a Nuclear Magnetic Resonance spectrum.

FIG. 2 is another Nuclear Magnetic Resonance spectrum.

### DETAILED DESCRIPTION OF ILLUSTRATIVE EMBODIMENT(S)

It is understood that the process is not limited to the particular methodology, protocols and reagents described herein, as these can vary as persons familiar with the technology involved here will recognize. It is also to be understood that the terminology used herein is used for the purpose of describing particular embodiments only, and is not intended to limit the scope of the process. It also is to be noted that as used herein and in the appended claims, the singular forms “a”, “an”, and “the” include the plural reference unless the context clearly dictates otherwise. Thus, for example, a reference to “a linker” is a reference to one or more linkers and equivalents thereof known to those skilled in the art. Similarly, the phrase “and/or” is used to indicate one or both stated cases can occur, for example, A and/or B includes (A and B) and (A or B).

Unless defined otherwise, technical, and scientific terms used herein have the same meanings as commonly understood by one of ordinary skill in the art to which the process pertains. The embodiments of the process and the various features and advantageous details thereof are explained more fully with reference to the non-limiting embodiments and/or illustrated in the accompanying drawings and detailed in the following description. It should be noted that the features illustrated in the drawings are not necessarily drawn to scale, and features of one embodiment can be employed with other embodiments as the skilled artisan would recognize, even if not explicitly stated herein.

Any numerical value ranges recited herein include all values from the lower value to the upper value in increments of one unit, provided that there is a separation of at least two units between any lower value and any higher value. As an example, if it is stated that the concentration of a component or value of a process variable such as, for example, size, angle size, pressure, time and the like, is, for example, from 1 to 98, specifically from 20 to 80, more specifically from 30 to 70, it is intended that values such as 15 to 85, 22 to 68, 43 to 51, 30 to 32, and the like, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

Moreover, provided immediately below is a “Definitions” section, where certain terms related to the process are defined specifically. Particular methods, devices, and materials are described, although any methods and materials similar or equivalent to those described herein can be used in the practice or testing of the process.

### Definitions

The term “polymer electrolyte membrane” as used here refers to both cation exchange membranes, which generally comprise polymers having multiple covalently attached negatively charged groups, and anion exchange membranes, which generally comprise polymers having multiple covalently attached positively charged groups. Typical cation exchange membranes include proton conducting membranes, such as the perfluorosulfonic acid polymer available under the trade designation NAFION® from E. I. du Pont de Nemours and Company (DuPont) of Wilmington, DE.

The term “anion exchange membrane electrolyzer” as used here refers to an electrolyzer with an anion-conducting polymer electrolyte membrane separating the anode from the cathode.

The term “EMIM” as used here refers to 1-ethyl-3-methylimidazolium cations.

The term “CV” refers to cyclic voltammetry.

The term “Millipore water” is water that is produced by a Millipore® filtration system with a resistivity of at least 18.2 megaohm-cm.

The term “imidazolium” as used here refers to a positively charged ligand containing an imidazole group. This includes a bare imidazole or a substituted imidazole. Ligands of the form:

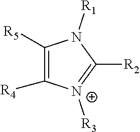

where R₁-R₅ are each independently selected from hydrogen, halides linear alkyls, branched alkyls, cyclic alkyls, heteroalkyls, aryls, heteroaryls, alkylaryls, heteroalkylaryls, and polymers thereof, such as the vinyl benzyl copolymers described herein, are specifically included.

The term “pyridinium” as used here refers to a positively charged ligand containing a pyridine group. This includes a bare pyridine or a substituted pyridine. Ligands of the form:

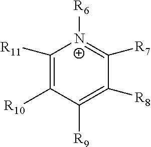

where R₆-R₁₁ are each independently selected from hydrogen, halides, linear alkyls, branched alkyls, cyclic alkyls, heteroalkyls, aryls, heteroaryls, alkylaryls, heteroalkylaryls, and polymers thereof, such as the vinyl benzyl copolymers described herein, are specifically included.

The term “phosphonium” as used here refers to a positively charged ligand containing phosphorous. This includes substituted phosphorous. Ligands of the form:

P⁺(R₁₂R₁₃R₁₄R₁₅)

where R₁₂-R₁₅ are each independently selected from hydrogen, halides, linear alkyls, branched alkyls, cyclic alkyls, heteroalkyls, aryls, heteroaryls, alkylaryls, heteroalkylaryls, and polymers thereof, such as the vinyl benzyl copolymers described herein, are specifically included.

The term “positively charged cyclic amine” as used here refers to a positively charged ligand containing a cyclic amine. This specifically includes imidazoliums, pyridiniums, pyrazoliums, pyrrolidiniums, pyrroliums, pyrimidiums, piperidiniums, indoliums, triaziniums, and polymers thereof, such as the vinyl benzyl copolymers described herein.

The term “simple amine” as used here refers to a species of the form:

N(R₁₆R₁₇R₁₈),

wherein R₁₆, R₁₇ and R₁₈ are each independently selected from hydrogen, linear alkyls, branched alkyls, cyclic alkyls, heteroalkyls, aryls, heteroaryls, alkylaryls, heteroalkylaryls, but not polymers.

The term “substituted ethene” as used here refers to a monomer of the form:

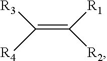

wherein R₁-R₄ are each independently selected from hydrogen, halides, linear alkyls, branched alkyls, cyclic alkyls, heteroalkyls, aryls, heteroaryls, alkylaryls, heteroalkylaryls, including polymers.

The term “TMIM” as used here refers to Tetramethylimidazole.

The term “water purification system” as used here refers to a device that removes unwanted constituents from water and, in the case of a membrane-based device, one that employs a membrane as a barrier that allows certain substances to pass through while blocking others.

The term “battery” as used here refers to a device that generates electricity via an electrochemical reaction between substances stored internally within the battery.

The term “fuel cell” as used here refers to a device that generates electricity via an electrochemical reaction between substances that are supplied to the fuel cell from an external source.

The term “electrolyzer” as used here refers to an electrochemical device that uses electrical energy to convert a substance into constituent substances. In the case of a water electrolyzer, the device uses electricity to convert water into hydrogen and oxygen.

The term “CO₂ capture system” as used here refers to a device that is able to separate CO₂ from a gas or liquid stream.

### Specific Description

The examples provided here are merely illustrative and are not meant to be an exhaustive list of all possible embodiments, applications, or modifications of the present electrochemical device. Thus, various modifications and variations of the described methods and systems of the invention will be apparent to those skilled in the art without departing from the scope of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

### Specific Example 1: Production of Alternative Membranes

The objective of Example 1 was to provide a number of alternate membranes that are useful for the electrolysis of water and carbon dioxide, batteries, electric power generation using fuel cells and water purification.

Generally, the synthesis procedure for the membranes in Example 1 starts with the procedure laid out in U.S. Pat. No. 9,370,773 but then adds additional steps 5 and 6.

Step 1: The inhibitor free styrene was prepared by washing styrene (Sigma Aldrich, Saint Louis, MO) with two equal volumes of 7.5% aqueous sodium hydroxide. The inhibitor free styrene was then washed with four equal volumes of water to ensure neutralization and was then dried over anhydrous magnesium sulfate. The tert-butylcatechol (TBC) inhibitor in the vinylbenzyl chloride (VBC) was removed by extraction with 0.5% potassium hydroxide solution until a colorless extract was obtained. This extract was washed with water until neutral and then dried over anhydrous magnesium sulfate.

Step 2: Poly (vinylbenzyl chloride-co-styrene) was then synthesized by heating a solution of inhibitor free styrene (Sigma-Aldrich) (440 g) and vinylbenzyl chloride (Dupont) (360 g) in 2 liters of chlorobenzene (Sigma-Aldrich) at 60-65° C. in a water jacketed reactor for 12-18 hours under nitrogen gas with AIBN (α,α′-Azoisobutyronitrile, Sigma-Aldrich) (8 g) as initiator. The resulting copolymer was precipitated in ethanol and dried under vacuum.

Step 3: A sample of the resulting copolymer from Step 2 was dissolved in 1-methoxy-2-propanol (Sigma Aldrich) to form a solution that was 27-32% by weight of the polymer.

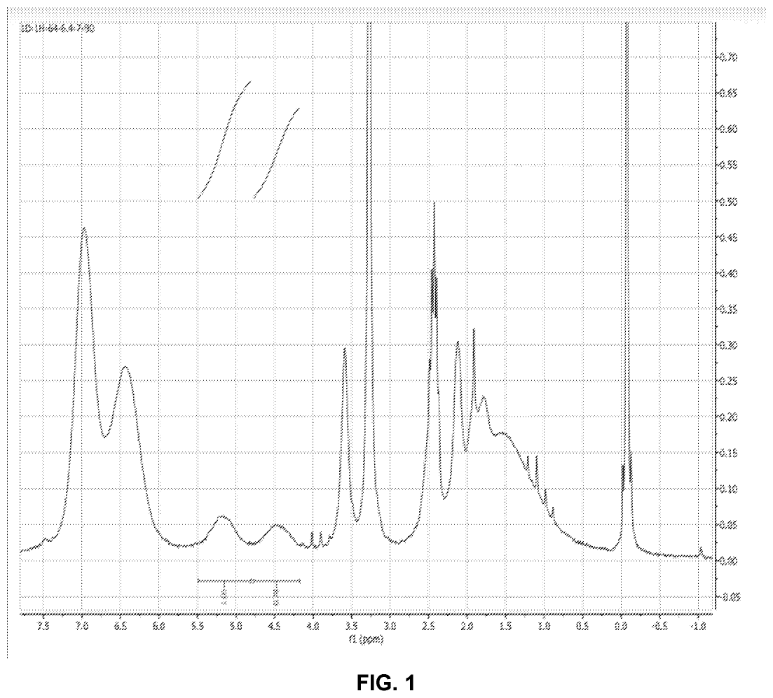

Step 4: The solution from Step 3 was heated to 60° C., and tetramethyl imidazole was added and the solution was continuously stirred for 48 hours. Nuclear Magnetic Resonance (NMR) indicated that approximately 40% of the vinylbenzyl chloride (VBC) was unreacted at this point. FIG. 1 shows the NMR spectrum taken after Step 4.

Step 5:5 mL of the solution from Step 4 was added to a series of 20 ml vials. One of the following amines was added to each of the vials: triethylamine, tripropylamine, ethanolamine, 3-(dimethylamino)-1-propylamine, hexylamine, 1-methylpiperidine, 1-piperidineethanol, 1-benzylimidazole, 4-(dimethylamino) pyridine, N-methyl-D-glucamine, decylamine (all purchased from Sigma Aldrich). The vials were heated to 45° C. in a shaker bath for 48 hours.

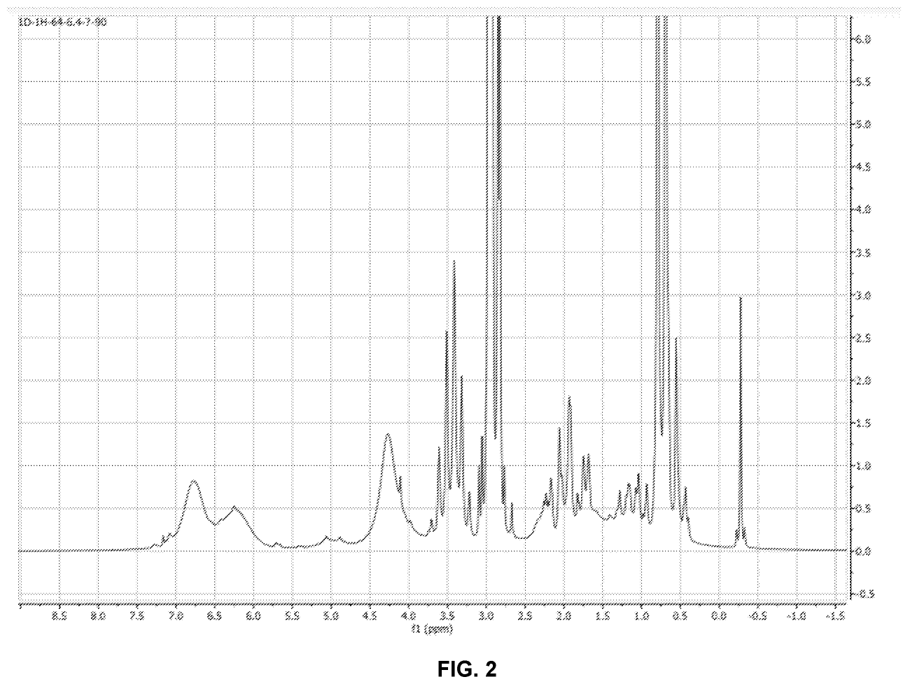

Step 6: A second set of vials identical to those in Step 5 were prepared. The vials were cooled to room temperature and 2.4 mL of a 21% solution of ethoxy sodium (also called sodium ethoxide) (C₂H₅ONa) (Sigma Aldrich) in ethanol was added to each of the vials. 2 mL of a 21% solution of ethoxy sodium in ethanol were also added to a vial containing the solution from Step 4. In each case the vial was put in the shaker for 5-10 minutes. NMR indicated less than 1% of the unreacted VBC remained at this point. FIG. 2 shows the NMR spectrum taken after Step 5.

Step 7: An attempt was made to manufacture membranes from each of the solutions prepared in Step 5 and Step 6 by casting the solution directly onto a polyethylene terephthalate (PET) liner. The thickness of the solution on the liner was controlled by a film applicator (MTI Corporation, Richmond, CA) with an adjustable doctor blade. The membranes were then dried in an oven at 60° C. for 120-150 minutes. Each of the resulting membranes was soaked in 1 molar KOH overnight then washed with deionized water (DI water). The membranes had a thickness between 40 and 100 microns at this point.

Next the water permeability of each of the membranes was measured as follows:

Step 8: Each membrane was mounted between the anode and cathode of Dioxide Materials® 25 cm² electrolyzer hardware with a Polyetheretherketone (PEEK) mesh as a support.

Step 9: 1 molar KOH was circulated through the anode of the cell hardware, while 1 L/min of dry nitrogen was fed into the cathode of the cathode. The electrolyzer hardware was heated to 60° C. and allowed to equilibrate.

Step 10: The gas leaving the electrolyzer was directed into a cold trap and cooled with dry ice for 20 minutes. The cold trap was then weighed, and the weight of water that condensed in the trap was calculated as the difference between the initial weight of the flask and the weight with condensed water. The results are given in Table 1.

TABLE 1
The weight of the water collected in Step 10 as a
function of the compounds used in Steps 4, 5 and 6

| | | | | Water |
|---|---|---|---|---|
| | Step 4 | Step 5 | Step 6 | permeation rate |
| Case | amine | amine | compound | 10⁻⁵ gm/cm² s |
| 1 | TMIM | None | None | 5.87 |
| 2 | TMIM | Tripropylamine | None | 5.92 |
| 3 | TMIM | Triethylamine | None | ** |
| 4 | TMIM | 1-benzylimidazole | None | 6.28 |
| 5 | TMIM | 1-piperidineethanol | None | * |
| 6 | TMIM | 4-dimethylaminopyridine | None | * |
| 7 | TMIM | 1-methylpiperidine | None | * |
| 8 | TMIM | N methyl pyrrolidine | None | * |
| 9 | TMIM | N-methyl-d-glucamine | None | 6.15 |
| 10 | TMIM | None | ethoxy | 6.23 |
| | | | sodium | |
| 11 | TMIM | Tripropylamine | ethoxy | 6.39 |
| | | | sodium | |
| 12 | TMIM | Triethylamine | ethoxy | ** |
| | | | sodium | |
| 13 | TMIM | 1-benzylimidazole | ethoxy | 6.52 |
| | | | sodium | |
| 14 | TMIM | 1-piperidineethanol | ethoxy | 5.73 |
| | | | sodium | |
| 15 | TMIM | 4-dimethylaminopyridine | ethoxy | 6.47 |
| | | | sodium | |
| 16 | TMIM | 1-methylpiperidine | ethoxy | 7.09 |
| | | | sodium | |
| 17 | TMIM | N methyl pyrrolidine | ethoxy | 6.73 |
| | | | sodium | |
| 18 | TMIM | N-methyl-d-glucamine | ethoxy | 6.28 |
| | | | sodium | |

Membranes labeled with an * became a gel under aqueous conditions. They fell apart during the test. Membranes labeled with an ** developed a hole due to trapped air bubbles.

The results in Table 1 illustrate that membranes with over a 20% higher water conductivity compared to those produced in Case 1 can be created. This results in enough extra permeation to make the membranes usable in a water electrolyzer with a dry cathode. In all cases, the addition of ethoxy sodium in Step 6 increased the water conductivity of the membrane compared to similar membranes that did not undergo Step 6.

The data in Table 1 also shows a surprise: the membranes in cases 3, 5, 6, 7 and 8 were too soft to be useful but when sodium ethoxide was added to the solutions before casting, reasonably strong membranes were obtained.

When the solutions from Step 6 were left overnight the solutions turned into a gel. This suggests that the sodium ethoxide solution is not simply reacting with unreacted chlorines in the membrane. Instead, the sodium ethoxy is somehow catalyzing cross linking of the membrane. Previously examples of sodium ethoxide or related compounds acting to catalyze crosslinking of a membrane are unknown.

Membranes manufactured by the procedures described in Li et al., “Novel anion exchange membranes based on polymerizable imidazolium salt for alkaline fuel cell applications”, Journal of Material Chemistry 21 (2011), pp. 11340-11346; and Lin et al., “Alkaline Stable C2-Substituted Imidazolium-Based Anion-Exchange Membranes”, Chemistry of Materials 25 (2013), pp. 1858-were also tested. Polymers manufactured by these procedures were not mechanically robust.

### Example 2: Changing Concentrations

The data in Example 1 was taken under conditions where the VBC constituted 43-46% of the total weight of the co-polymer produced in Step 2. However, U.S. Pat. No. 9,370,773 shows that useful polymers can be made with copolymers containing 10, 20, 30, 40, 40, 60, 70, 80, or 90% each±5% by weight of VBC. Similarly, the data in Example 1 was taken where 58-62% of the VBC in the copolymer reacted with TMIM in Step 4. By changing the reaction time, one can react 1, 5, 10, 20, 30, 40, 50, 60% each ±5% of the VBC with TMIM in Step 4.

The results also show that that one can react at least 70%, at least 80%, at least 90% or at least 95% each +5% of the VBC with TMIM if 1-methoxy-2-propanol in Step 3 is replaced with dimethylformamide. The resultant polymers can comprise all of, or at least some of; the ranges between about 10, 20, 30, 40, 50, 60, 70, or 80% by weight of styrene; all of, or at least some of, the ranges between 10, 20, 30, 40, 50, 60, 70, 80 or 90% by weight of vinylbenzyl-Rₛ; and/or all of, or at least some of, the ranges between 1, 5, 10, 20, 30, 40, 50, 60, 70% by weight of vinylbenzyl-Rₓ.

The examples given above are merely illustrative and are not meant to be an exhaustive list of all possible embodiments, applications, or modifications of the present electrochemical device. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

The disclosures of all references and publications cited above are expressly incorporated by reference in their entireties to the same extent as if each were incorporated by reference individually.

In particular, the U.S. Pat. Nos. 9,012,345; 9,370,773; 9,464,359; 9,481,939; 9,580,824; 9,555,367; 9,815,021; 9,849,450; 9,943,841; 9,945,040; 9,957,624; 9,982,353; 10,023,967; 10,047,446; 10,975,480; 10,147,974; 10,173,169; 10,396,329; 10,428,432; 10,724,142; 10,774,431 patents and Ser. Nos. 15/922,883; 16/024,827; 16/552,952; 16/429,868 applications are hereby incorporated by reference herein in their entireties.

While particular elements, embodiments and applications of the present invention have been shown and described, it will be understood that the invention is not limited thereto since modifications can be made by those skilled in the art without departing from the scope of the present disclosure, particularly in light of the foregoing teachings.

What is claimed is:

1. An anion-conducting membrane comprising a polymer comprising a reaction product of a vinylbenzyl-Rₛ, a vinylbenzyl-Rₓ and a styrene, wherein:
(a) said vinylbenzyl-Rₛ comprises a reaction product of tetramethylimidazolium and benzylchloride;
(b) said vinylbenzyl-Rₓ comprises a reaction product of benzylchloride and at least one of the following compounds: sodium-ethoxide, tripropyl amine, triethylamine, benzimidazole, 1-piperidineethanol, dimethylaminopyridine, 1 methyl pyrrolidine, methylpiperidine, N-methyl-D-glucamine;
(c) the total weight of said vinylbenzyl-Rₛ is at least 20% of the weight of said polymer;
(d) the total weight of said vinylbenzyl-Rₓ is at least 10% of the weight of said polymer; and
(e) the total weight of said styrene is at least 20% of the weight of said polymer.

2. The anion-conducting membrane of claim 1, wherein the total weight of vinylbenzyl-Rₓ is at least 20% of the weight of said polymer.

3. The anion-conducting membrane of claim 1, wherein a step in the production of said anion-conducting membrane involves exposing said anion-conducting membrane to sodium ethoxide.

4. The anion-conducting membrane of claim 1, wherein vinylbenzyl-Rₓ comprises a reaction product of benzylchloride and N-methyl-D-glucamine.

5. The anion-conducting membrane of claim 1 where said anion-conducting membrane comprises a reaction product of said vinylbenzyl-Rₛ, a vinylbenzyl-Rₓ₁, a vinylbenzyl-Rₓ₂ and said styrene, further comprising wherein:
(a) said vinylbenzyl-Rₓ₁ comprises a reaction product of benzylchloride and at least one of the following compounds: sodium-ethoxide, tripropyl amine, triethylamine, benzimidazole, 1-piperidineethanol, dimethylaminopyridine, 1 methyl pyrrolidine, methylpiperidine, N-Methyl-D-glucamine;
(b) said vinylbenzyl-Rₓ₁ comprises a reaction product of benzylchloride and ethoxy-sodium;
(c) the polymer comprises at least 1% of said vinylbenzyl-Rₓ₁; and
(d) the polymer comprises at least 10% of said vinylbenzyl-Rₓ₂.

6. The anion-conducting membrane in claim 1, wherein the polymer has a molecular weight between 1000 and 10,000,000 atomic units (A.U.).

7. The anion-conducting membrane of claim 1, wherein the thickness of said anion-conducting membrane is between 10-300micrometers.

8. The anion-conducting membrane of claim 1, wherein the anion-conducting membrane has an area specific resistance of 0.1 ohm-cm² or less in 1 M KOH at 60° C.

9. A battery, a fuel cell, an electrolyzer, a water purification system or a CO₂ capture system comprising the anion-conducting membrane of claim 1.
